(19) United States
(12) Patent Application Publication
(10) Pub. No.: US 2005/0010459 A1
(43) Pub. Date: Jan. 13, 2005

(54) Project pre-review estimate method

(75) Inventors: Kaoru Kawabata, Hitachi (JP); Takeshi Yokota, Hitachi (JP); Shigeru Sato, Niiza (JP)

Correspondence Address: McDermott, Will & Emery, 600 13th Street, N.W., Washington, DC, 20005-3096, US

(73) Assignee: HITACHI, LTD.

(21) Appl. No.: 10/885,036

(22) Filed: Jul. 7, 2004

(30) Foreign Application Priority Data
Jul. 8, 2003 (JP) 2003-272068

(51) Int. Cl. G06F 17/60

(52) U.S. Cl. 705/7

(57) ABSTRACT

A project pre-review estimate method capable of estimating influence of alteration in each process of a project on the whole process (project) considering structural alteration and fluctuating values regarding each process and their factors is provided. The project pre-review estimate method is carried out employing a process evaluation procedure which calculates quantitative and structural alteration amounts of the process plan using not only information on constraints (which has been used by conventional techniques) but also scenario information (in which probability of occurrence of a risk (i.e. a factor of alteration to a process) and the content/degree of influence regarding alteration of arbitrary processes caused by the occurrence of the risk are defined in a scenario format) and information for correcting parameters of the scenario by use of qualitative information on the project.

### BACKGROUND OF THE INVENTION

The present invention relates to a process management method for a project, and in particular, to a project pre-review estimate method to be employed for risk management of a project for estimating influence of alteration of a process plan on the whole project.

In process management of a project, influence of alteration of the period of a process (period during which the process is conducted) on other processes is generally estimated in conventional techniques based on period constraints (specifying a practicable period of each process) and ordinal constraints (defining relationship regarding executing order of processes) by calculating how the amount of alteration (hereinafter also referred to as “alteration amount”) of the period of a process propagates into other relevant processes (having the ordinal constraints with the process) within the period constraints. As an example of such a conventional process management method, in a project management system disclosed in JP-A-10-240804 (paragraphs [0065]-[0076], FIG. 8), delay in the progress of a process is compensated for and the whole process (project) is adjusted and normalized, by allotting shortened periods to posterior processes.

Meanwhile, as an example of a method to be used for risk management of a project for quantitatively estimating the influence of a risk (that might occur) on the project based on probability of occurrence and degree of influence of the risk, a project risk management support device has been disclosed in JP-A-2001-195483 (claim 1, FIG. 1). The project risk management support device of the patent document quantifies risks in a project to be launched by retrieving data on similar projects conducted in the past and outputs the result in a graphics display format. Incidentally, the “risk” in process management means a factor of alteration of a process.

### SUMMARY OF THE INVENTION

In the project management system of JP-A-10-240804, the propagation of the alteration amount (delay time) of a process plan is defined as a fixed value. Therefore, the adjustment for letting the whole process plan absorb the alteration amount of a process was only possible in consideration of the simple summation of alteration amounts which can be absorbed by respective process. However, in actual plans, the propagation of the alteration amount of a process plan does not necessarily become a fixed value and can vary depending on the content of each process and each risk that can occur.

Meanwhile, the project risk management support device of JP-A-2001-195483 was capable of no more than displaying accumulated information on risks concerning similar projects of the past on its display unit as fixed values. However, since the project risks also do not necessarily become fixed values and can vary due to fluctuating values regarding each process and structural change of the project itself, the project risk management support device might display risks that do not hold for the actual project.

It is therefore the primary object of the present invention to provide a method capable of estimating influence of alteration in each process of the project on the whole process (project) with high accuracy considering structural alteration and fluctuating values in each process of the project and their factors.

A project pre-review estimate method in accordance with the present invention which has been made for resolving the above problems is carried out employing a process evaluation or estimation procedure which calculates quantitative and structural alteration amounts of a process plan using not only the information on constraints (which has been used by conventional techniques) but also scenario information (in which probability of occurrence of each risk and the content/degree of influence regarding alteration of particular processes caused by the occurrence of the risk are defined in a scenario format) and qualitative information on the particular processes, by which influence of alteration of the process plan on the project can be estimated with high accuracy.

In the project pre-review estimate method of the present invention, by use of information on the processes, the process plan can be evaluated with high accuracy considering structural alteration such as quantitative alteration to the processes and addition/deletion of processes.

### BRIEF DESCRIPTION OF THE DRAWINGS

The objects and features of the present invention will become more apparent from the consideration of the following detailed description taken in conjunction with the accompanying drawings, in which:

FIG. 1 is a functional block diagram showing an example of the composition of an evaluation device employing a project pre-review estimate method in accordance with an embodiment of the present invention;

FIG. 2 is a table showing an example of items of a table stored in a process database of the evaluation device;

FIG. 3 is a table showing a format of a scenario which designates alteration to quantitative information on a process;

FIG. 4 is a table showing an example of a scenario which designates alteration to quantitative information on a process;

FIG. 5 is a table showing a format of a scenario which designates structural addition of one or more processes;

FIG. 6 is a table showing a format of a scenario which designates structural replacement (addition and deletion) of one or more processes;

FIG. 7 is a table showing a format of a scenario which designates structural deletion of one or more processes;

FIG. 8A is a table showing the contents of a table stored in a correction coefficient database of the evaluation device, in which risk evaluations corresponding to qualitative information are registered;

FIG. 8B is a table showing the contents of another table stored in the correction coefficient database, in which information on classification of a total risk evaluation into types is registered;

FIG. 8C is a table showing the contents of another table stored in the correction coefficient database, in which information (coefficients) used for correcting scenario occurrence probability and scenario influence degree is registered;

FIG. 9 is a table showing the contents of another table stored in the correction coefficient database, which indicates correlations between scenarios;

FIG. 10 is a flow chart showing a procedure for evaluating a process plan of a project which is carried out by the evaluation device;

FIG. 11 is a table showing the contents of an evaluation result database of the evaluation device corresponding to a sub-process;

FIG. 12 is a schematic diagram showing an example of a display screen of the evaluation device which is used for referring to basic information and quantitative information on sub-processes and inputting the number of simulations and a percentile;

FIG. 13 is a schematic diagram showing an example of a display screen of the evaluation device for inputting qualitative information on a process;

FIG. 14 is a schematic diagram showing an example of a display screen of the evaluation device for displaying results of evaluation of the process plan; and

FIG. 15 is a schematic diagram showing an example of a frequency distribution display screen of the evaluation device, regarding particular quantitative information.

### DESCRIPTION OF THE EMBODIMENTS

Referring now to the drawings, description will be given in detail of some embodiments in accordance with the present invention, wherein like reference characters designate like or corresponding parts or elements throughout the views. First, an example of the composition of an evaluation device employing a project pre-review estimate method in accordance with the present invention will be described.

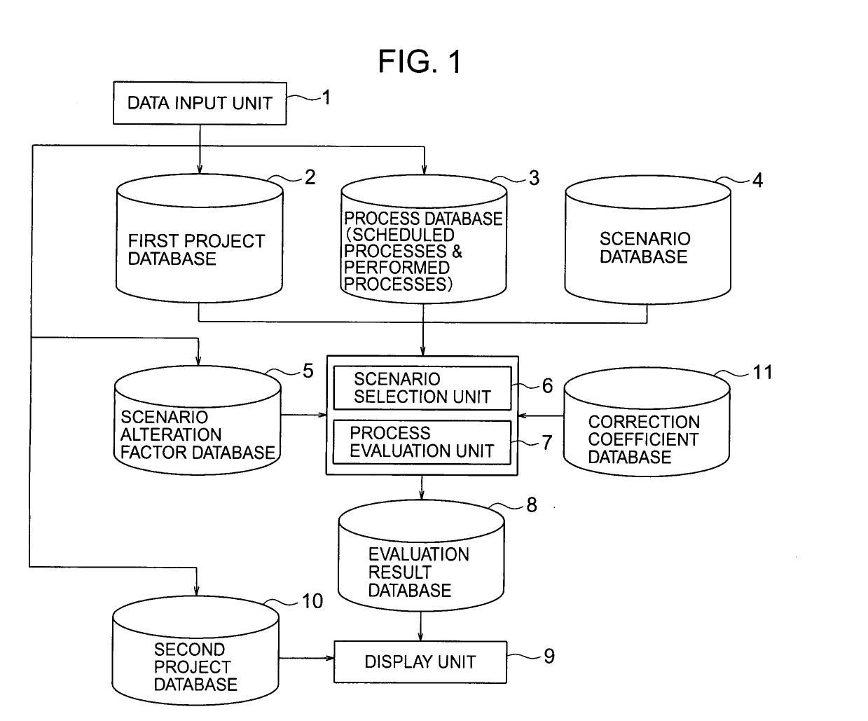

FIG. 1 is a functional block diagram showing an example of the composition of an evaluation or estimation device employing a project pre-review estimate method in accordance with an embodiment of the present invention. Referring to FIG. 1, the evaluation device includes a data input unit 1 for inputting data to each database which will be explained below, a first project database 2 for storing information on an evaluation method, a process database 3 for storing information on performed processes and scheduled processes of the project up to the present point in time, information on constraints, etc., a scenario database 4 for storing information on contents of alterations to processes, in regard to each scenario as a process alteration factor, a scenario alteration factor database 5 for storing qualitative information on the project, a second project database 10 for storing information on a method for displaying evaluation results, a correction coefficient database 11 for storing information to be used for correcting scenario occurrence probability and scenario influence degree, a scenario selection unit 6 for selecting a scenario to be used for “simulations” which will be explained below, a process evaluation unit 7 for calculating variation of quantitative information on each process by calculating quantitative data and structural data concerning the process based on information stored in each database and the scenario selected by the scenario selection unit 6, an evaluation result database 8 for storing the variation of the quantitative information calculated by the process evaluation unit 7, a display unit 9 for displaying the results of process evaluation based on the information stored in the second project database 10 and the evaluation result database 8. Each database mentioned above corresponds to storage means in the appended claims.

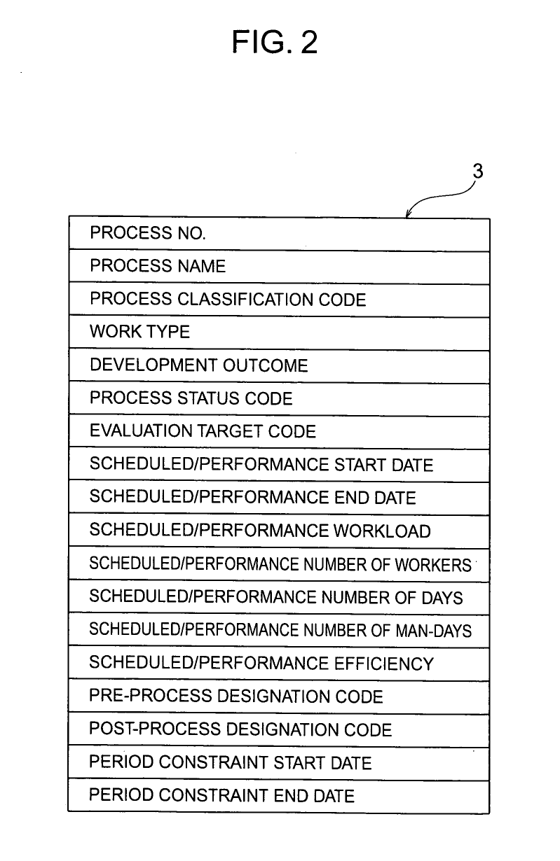

In the following, information stored in each database of the evaluation device employing the project pre-review estimate method in accordance with the present invention (hereinafter simply referred to as “the evaluation device”) will be described. First, in the process database 3. for storing the information on the performed processes and the scheduled processes and the information on the constraints, each table containing a plurality of items is defined for each process and stored. As shown in FIG. 2, each table defined for a process contains, for example, “process No.” which is uniquely assigned to the process, “process name” as the name of the process, “process classification code” as a code indicating a class into which the process is classified, “work type” as a code indicating the type of work executed in the process, “development outcome” as a code assigned to the outcome of the process, “process status code” as a code indicating whether the process has already been executed (code: 1) or not (code: 0) (i.e. whether the following data of the process are performance data or scheduled data), “evaluation target code” indicating whether the process is a target of evaluation (code: 1) or not (code: 0), “scheduled/performance start date” indicating the start date of the process as scheduled data or performance data, “scheduled/performance end date” indicating the end date of the process as scheduled data or performance data, “scheduled/performance workload”, “scheduled/performance number of workers”, “scheduled/performance number of days”, “scheduled/performance number of man-days” as the product of the number of workers and the number of days, “performance efficiency” as the ratio of the performance number of man-days to the scheduled number of man-days (“1” is set before the process is conducted), “pre-process designation code” as one of ordinal constraints, in which the process No. of each process that have to be ended before the process of the table is started and the process No. of each process that starts simultaneously with the process of the table are designated, “post-process designation code” as another one of the ordinal constraints, in which the process No. of each process that can not be started until the process of the table is ended and the process No. of each process that ends simultaneously with the process of the table are designated, “period constraint start date” as one of period constraints, indicating the first date of the period in which the process can be conducted, and “period constraint end date” as another one of the period constraints, indicating the last date of the period in which the process can be conducted. Incidentally, as the process classification code, a code corresponding to the content of work conducted in the process (e.g. planning=1, design=2, development=3, evaluation=4) is entered.

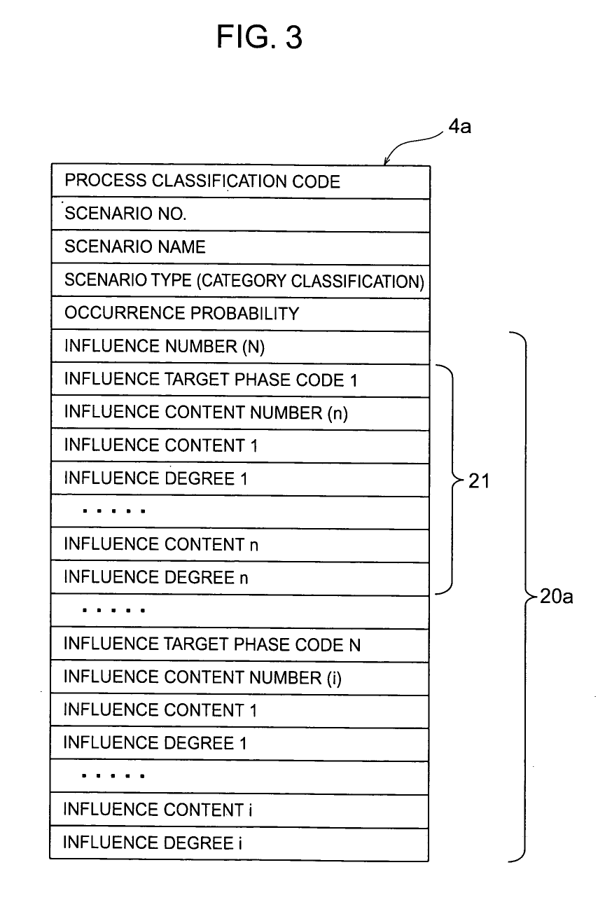

Next, in the scenario database 4 for storing information on alterations to the processes, each table is defined for each scenario and stored in a format which is selected from the formats shown in FIGS. 3 through 7 (for example) depending on the content of the scenario. For example, the format 4a shown in FIG. 3 is a format for a scenario which designates alteration to quantitative information on a process. The format 4a includes “process classification code” indicating the class of a process to which the scenario occurs (identical with the process classification code in the process database 3), “scenario No.” which is uniquely assigned to the scenario, “scenario name” as the name of the scenario, “scenario type” as a code indicating a category into which the scenario is classified (the format 4a is classified into “category 1”, for example), “occurrence probability” indicating the probability of occurrence of the scenario, and “influence information 20a” indicating the influence of the scenario.

The influence information 20a includes N influence content groups 21 (N: “influence number” indicating the number of influences of the scenario). Each influence content group 21 includes “influence target phase code” as information inputted to designate a process that is influenced by the influence content group, “influence content number (n)” indicating the number of influence contents included in the influence content group 21, n influence contents each of which indicates what (which parameter) is influenced, and n influence degrees corresponding to the n influence contents each of which indicates the degree of influence.

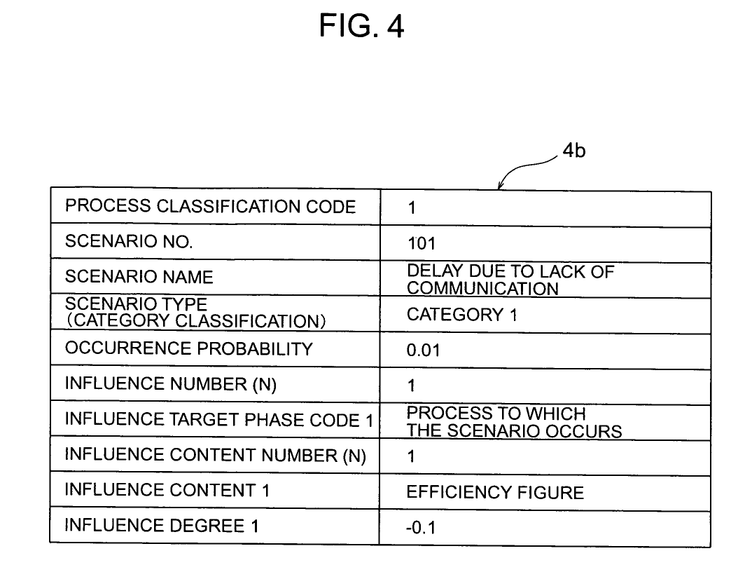

An example of a scenario designating alteration to quantitative information on a process is shown in FIG. 4. The scenario shown in FIG. 4 is made by entering information on the actual scenario into the scenario format of FIG. 3. In the scenario, a code “1” (indicating that the scenario is a scenario that occurs to a process regarding planning) has been inputted as the process classification code (scenario code), “101” has been inputted as the scenario No. uniquely assigned to the scenario, “delay due to lack of communication” has been inputted as the scenario name, “category 1” (indicating that the scenario is a scenario that designates alteration to quantitative information on a process) has been inputted as the scenario type, “0.01” has been inputted as the occurrence probability of the scenario, “1” (indicating that the number of influence content groups included in or exerted by the scenario is 1) has been inputted as the influence number (N), “process to which the scenario occurs” has been inputted as the influence target phase code indicating which process is influenced, “1” has been inputted as the influence content number (n) indicating how many influence contents exist, “efficiency figure” has been inputted as the influence content indicating which parameter is influenced, and “−0.1” has been inputted as the influence degree indicating the degree of influence.

In short, the scenario “delay due to lack of communication” of FIG. 4 indicates that the scenario occurs to a process regarding planning with a probability of 1% and the efficiency figure of a process is reduced by 10% when the scenario occurs to the process. Incidentally, while “process to which the scenario occurs” has been designated as the influence target phase code (indicating which process is influenced) in the example of FIG. 4, when a particular process is influenced, a process No. uniquely assigned to the process may also be inputted as the influence target phase code.

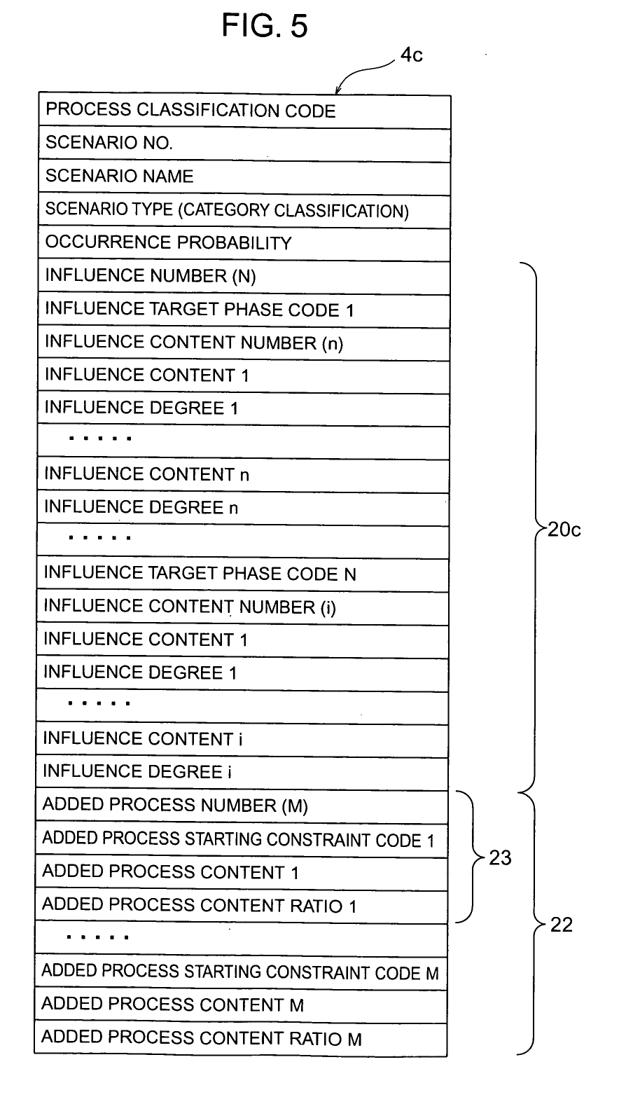

FIG. 5 shows a format 4c for a scenario which designates structural addition of one or more processes (category 2). The format 4c includes “process classification code” indicating the class of a process to which the scenario occurs (also identical with the process classification code in the process database 3), “scenario No.” which is uniquely assigned to the scenario, “scenario name” as the name of the scenario, “scenario type” as a code indicating a category into which the scenario is classified, “occurrence probability” indicating the probability of occurrence of the scenario, “influence information 20c” including information similar to that of the influence information 20a of the scenario 4a of FIG. 3, and “added process information 22” indicating information on processes added by the occurrence of the scenario. The added process information 22 includes M added process content groups 23 (M: “added process number” indicating the number of added processes). Each added process content group 23 includes “added process starting constraint code” indicating whether the added process is to be added to the starting point of the process (code: 1) or to the endpoint of the process (code: 0), “added process content” indicating a process code of a process as the copy source of the process to be added by the scenario, and “added process content ratio” indicating the ratio of the amount of the added process content to that of the added process content of the copy source.

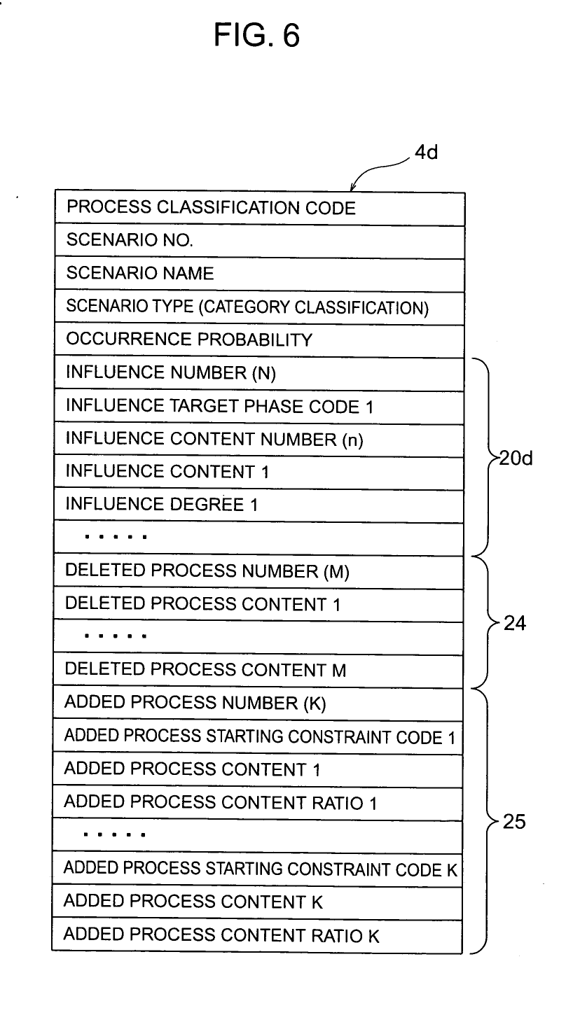

FIG. 6 shows a format 4d for a scenario which designates structural replacement (addition and deletion) of one or more processes (category 3). The format 4d includes “process classification code” indicating the class of a process to which the scenario occurs (also identical with the process classification code in the process database 3), “scenario No.” which is uniquely assigned to the scenario, “scenario name” as the name of the scenario, “scenario type” as a code indicating a category into which the scenario is classified, “occurrence probability” indicating the probability of occurrence of the scenario, “influence information 20d” including information similar to that of the influence information 20a of the scenario 4a of FIG. 3, “deleted process information 24” indicating information on processes deleted by the occurrence of the scenario, and “added process information 25” indicating information on processes added by the occurrence of the scenario. The deleted process information 24 includes M deleted process content groups (M: “deleted process number” indicating the number of deleted processes) each of which indicates the process code of a process to be deleted. The added process information 25 includes information similar to that of the added process information 22 of the scenario 4c of FIG. 5.

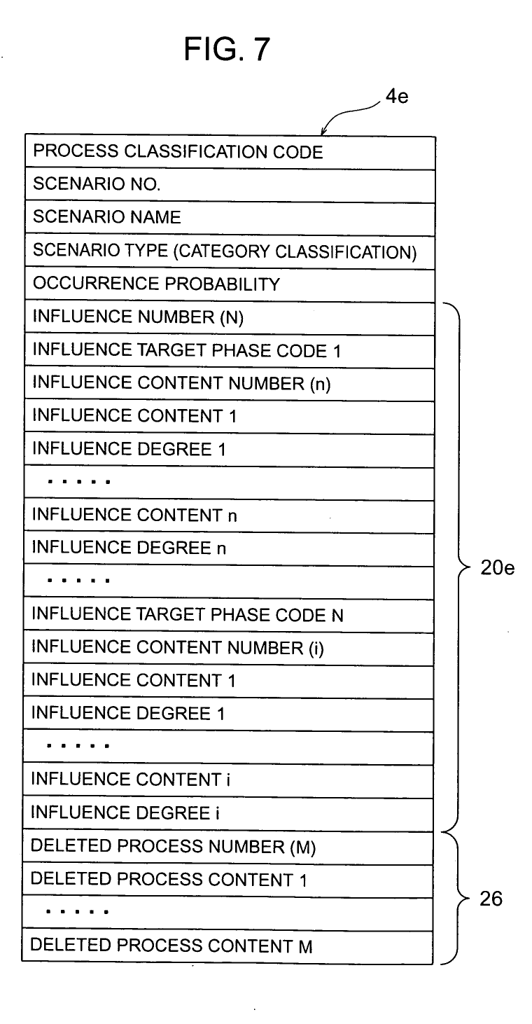

FIG. 7 shows a format 4e for a scenario which designates structural deletion of one or more processes (category 4). The format 4e includes “process classification code” indicating the class of the process to which the scenario occurs (also identical with the process classification code in the process database 3), “scenario No.” which is uniquely assigned to the scenario, “scenario name” as the name of the scenario, “scenario type” as a code indicating a category into which the scenario is classified, “occurrence probability” indicating the probability of occurrence of the scenario, “influence information 20e” including information similar to that of the influence information 20a of the scenario 4a of FIG. 3, and “deleted process information 26” indicating information on processes deleted by the occurrence of the scenario. Similarly to the deleted process information 24 shown in FIG. 6, the deleted process information 26 includes M deleted process content groups (M: deleted process number) each of which indicates the process code of a process to be deleted.

In the scenario database 4, a plurality of scenarios are defined and stored in the four formats explained above. Incidentally, the information entered into the formats corresponds to “information on specification change”, “information on specification addition”, “information on rework” and “information on interruption” in an appended claim.

Next, in the scenario alteration factor database 5 for storing qualitative information on the project, “scenario alteration factor information” about factors having influence on the occurrence probability (probability of occurrence) or the influence degree (degree of influence) of a scenario in the evaluation of the process plan is stored for each process, together with “process No.” indicating the process. The “scenario alteration factor information” includes, for example, information on “whether the contractor has experienced a similar project”, “whether the customer has experienced a similar project”, “whether development is carried out by experts or nonexperts”, “old customer or new customer”, “old subcontractor or new subcontractor” and “large-scale project or small-scale project”.

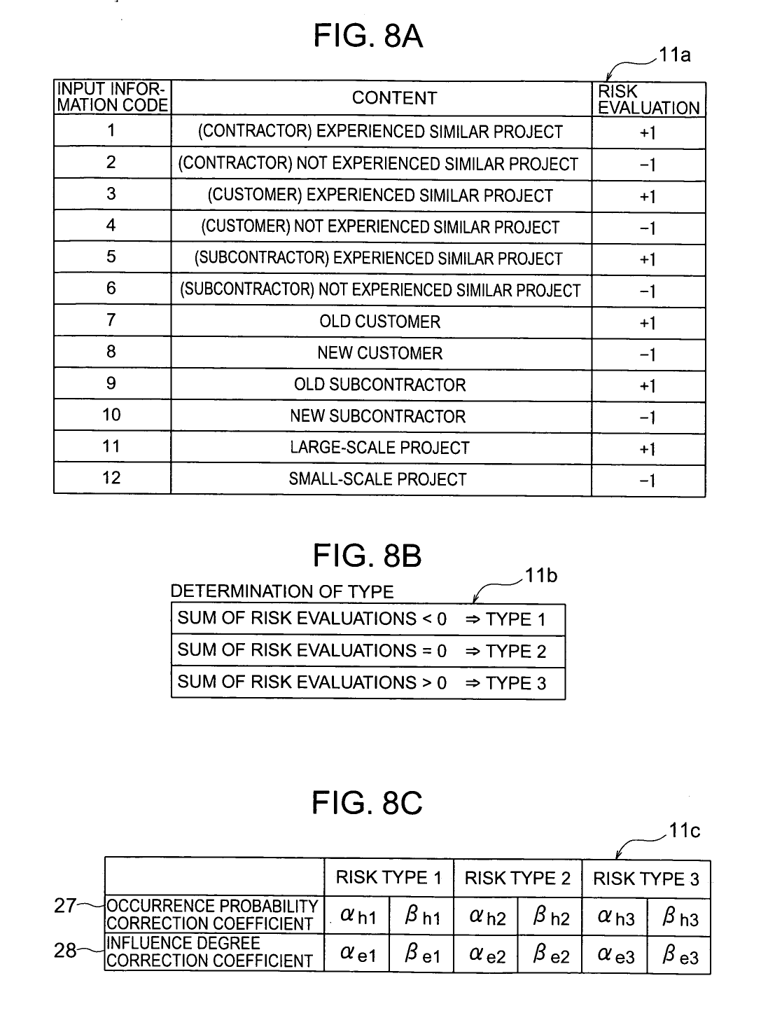

The correction coefficient database 11, for storing information to be used for correcting the scenario occurrence probability and the scenario influence degree, is composed of a Table 11a (in which risk evaluations corresponding to the qualitative information on the process registered with the scenario alteration factor database 5 are registered), a Table 11b (in which information on classification of a total risk evaluation (the sum of the risk evaluations) into types is registered) and a Table 11c (in which information (coefficients) used for correcting the scenario occurrence probability and the scenario influence degree is registered) which are shown in FIGS. 8A-8C, for example.

For example, when the qualitative information on a process registered with the scenario alteration factor database 5 includes information meaning “the contractor has experienced a similar project”, the scenario selection unit 6 of the evaluation device adds “+1” to the risk evaluation according to the information on the top of the Table 11a of FIG. 8A. The scenario selection unit 6 similarly adds up the risk evaluations for all pieces of qualitative information and then classifies “risk type” of the process into “type 1” (total risk evaluation<0), “type 2” (total risk evaluation=0) or “type 3” (total risk evaluation>0) based on the Table 11b of FIG. 8B. Thereafter, the scenario selection unit 6 corrects the occurrence probability of the scenario according to the following equation (1), by use of scenario occurrence probability correction coefficients 27 which are shown in the Table 11c of FIG. 8C.
[corrected occurrence probability]=αₕᵢ×[occurrence probability]+βₕᵢ (1)

Similarly, the scenario selection unit 6 corrects the influence degree of the scenario according to the following equation (2), by use of scenario influence degree correction coefficients 28 which are shown in the Table 11c of FIG. 8C. In the equations (1) and (2), the numerical subscript i of each coefficient is set to the risk type number.
[corrected influence degree]=αₑᵢ×[influence degree]+βₑᵢ (2)

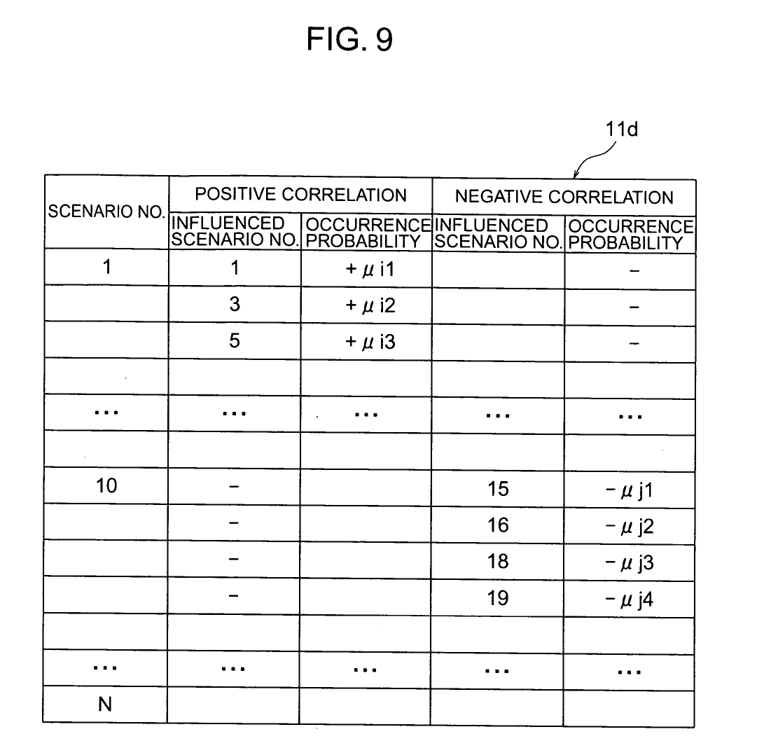

Incidentally, while the scenario selection unit 6 of the evaluation device of this embodiment corrected the occurrence probability of a scenario by use of the qualitative information of the process relevant to the scenario in the above example, the scenario selection unit 6 may also carry out the correction by additionally using a Table 11d shown in FIG. 9, which indicates correlations between scenarios. Also the Table 11d indicating the correlations between scenarios is stored in the correction coefficient database 11. In the Table 11d, information regarding the correlations are described for each scenario which is recognized by a scenario No. The information for each scenario includes scenario Nos. of scenarios having a positive correlation with the scenario, a correction value for the occurrence probabilities of the scenarios having the positive correlation, scenario Nos. of scenarios having a negative correlation with the scenario, and a correction value for the occurrence probabilities of the scenarios having the negative correlation. With the Table 11d, when a scenario occurs, the occurrence probabilities of scenarios having a positive/negative correlation with the scenario can be corrected by adding the correction values to the occurrence probabilities of the scenarios respectively.

In the first project database 2 for storing information on the evaluation method, “evaluation information” (the number of simulations, a percentile, random number type codes, etc.) to be used for the evaluation of a process is stored. In the second project database 10 for storing information on the method for displaying the evaluation results, “result displaying condition information” (screen template information, etc.) to be used for displaying the evaluation results of the project is stored.

The evaluation device employing the project pre-review estimate method in accordance with the present invention is typically implemented by a server computer, for example. Each database of the evaluation device is formed in an HDD (Hard Disk Drive) of the server computer. The data input unit 1 is implemented by a keyboard, mouse, CD-ROM (Compact Disc- Read Only Memory) drive, file input via a network, etc. The scenario selection unit 6 and the process evaluation unit 7 are implemented by loading a program (for realizing each procedure of the project pre-review estimate method) from the HDD into a RAM (Random Access Memory) of the evaluation device and running the program. The display unit 9 is implemented by displaying the evaluation result on a display device or by transmitting display screen information (for displaying the evaluation result) to other terminal devices via a network. The operation of the scenario selection unit 6 and the process evaluation unit 7 and the contents of the evaluation result database 8 will be explained in detail in the following explanation of “evaluation of a planning process”.

<Evaluation Procedure>

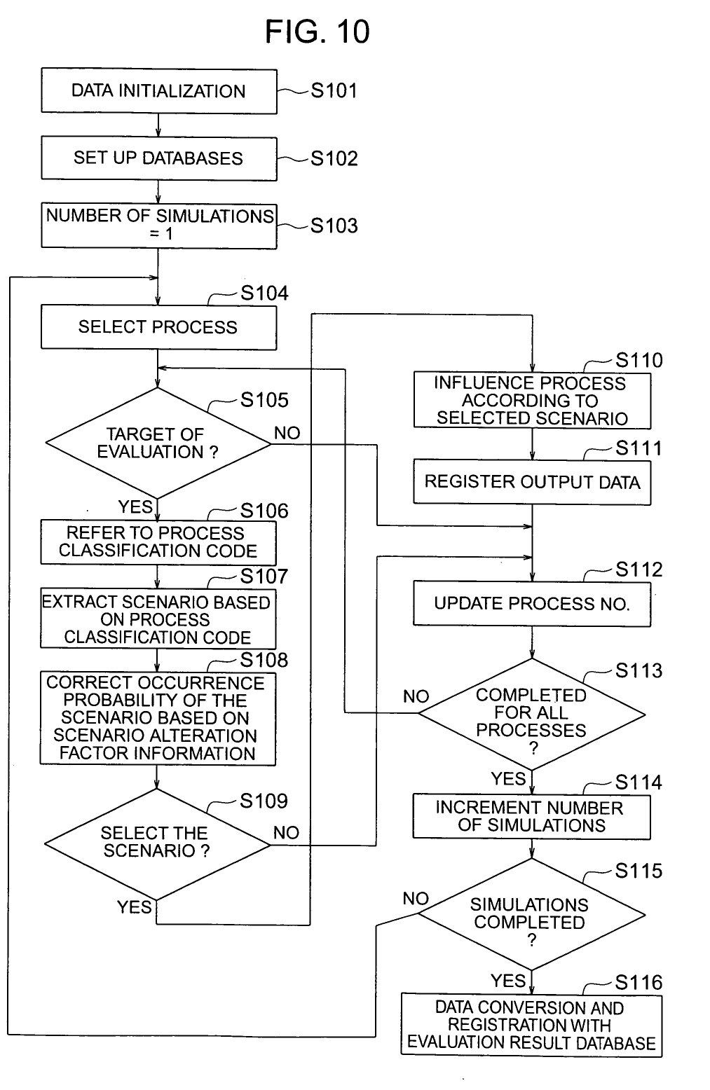

In the following, an example of evaluation of a process plan, carried out using the evaluation device employing the above project pre-review estimate method of the present invention, will be described in detail. FIG. 10 is a flow chart showing a procedure for evaluating the process plan of a project which is carried out by the evaluation device. The process evaluation procedure for the project will be explained in detail referring to the flow chart of FIG. 10 (and FIG. 1 as needed).

First, as preparation for the procedure, the evaluation device carries out data initialization by discarding or erasing data currently loaded therein (step S101). Subsequently, a proper database system is set up by inputting necessary data to the first project database 2, the second project database 10, the process database 3 and the scenario alteration factor database 5 through the data input unit 1 (step S102). Then, the evaluation device sets a counter indicating the number of evaluation simulations to 1 (step S103). In the step S102 in this embodiment, the qualitative information on the process to be inputted to the scenario alteration factor database 5, the number of simulations and the percentile to be inputted to the first project database 2, and the evaluation target code to be inputted to the process database 3 are entered by the user through a display screen which is equipped with a CGI (Common Gateway Interface) program (which will be described later), and the input of information to other databases is carried out by letting the CD-ROM drive read out data files of the CSV (Comma Separated Value) format from a prepared CD-ROM, for example.

Subsequently, the evaluation device selects each process one at a time (step S104) and judges whether the process actually exists and whether the process is a target of evaluation (step S105). If the process selected in the step S104 is a target of evaluation (YES in the step S105), the flow proceeds to the next step S106, otherwise (NO in the step S105) the flow proceeds to step S112. In the step S106 (when the process is an evaluation target), the evaluation device refers to the process classification code of the process (step S106) and extracts a scenario having the same process classification code from the scenario database 4 (step S107).

Subsequently, the evaluation device corrects the occurrence probability of the scenario (extracted in the step S107) based on the information stored in the scenario alteration factor database (qualitative risk database) 5 and the correction coefficient database 11 (step S108), and judges whether or not to select (adopt) the scenario extracted in the step S107 by use of the corrected occurrence probability of the scenario (step S109). The step S109 can be carried out by, for example, generating a random number between 0 and 1 for the Monte Carlo simulation. In this method, if the generated random number is the corrected occurrence probability or more, the evaluation device judges that the scenario will occur and thereby selects the scenario and proceeds to step S110. On the other hand, if the generated random number is less than the corrected occurrence probability, the evaluation device judges that the scenario will not occur and thereby proceeds to the step S112 without selecting the scenario. Incidentally, the step S109 corresponds to the scenario selection unit 6 in the block diagram of FIG. 1.

In the case where the evaluation device judges that the scenario will occur (YES in the step S109), the evaluation device carries out a proper processes depending on the content of the selected scenario (step S110). In the step S110, the evaluation device carried out alteration of quantitative data regarding influenced processes, erasure of existing processes for deleting a process, etc. according to the description of the selected scenario. The step S110 corresponds to the process evaluation unit 7 in the block diagram of FIG. 1. The evaluation device successively registers the results of the step S110 with its temporary storage (the RAM or the HDD) (step S111). Subsequently, the evaluation device selects the next process (step S112) and returns to the step S105 to repeat the sequence from the step S105 to the step S113 for the next process if the sequence has not been executed for all the processes (NO in step S113). If the sequence has been completed for all the processes (YES in the step S113), the evaluation device increments the number of simulations (step S114).

In the next step S115, if the number of simulations which has been registered with the first project database 2 has not been reached yet (NO in step S115), the evaluation device returns to the step S104 and repeats the sequence from the step S104 to the step S114. When the number of simulations registered with the first project database 2 is reached (YES in the step S115), the evaluation device summarizes alteration amounts of the processes which have been registered with the temporary storage in the step S111, obtains frequency distribution data, and registers the frequency distribution data with the evaluation result database 8 (step S116). By the above process flow, the evaluation of the process plan of the project is carried out and the results of the evaluation are registered with the evaluation result database 8.

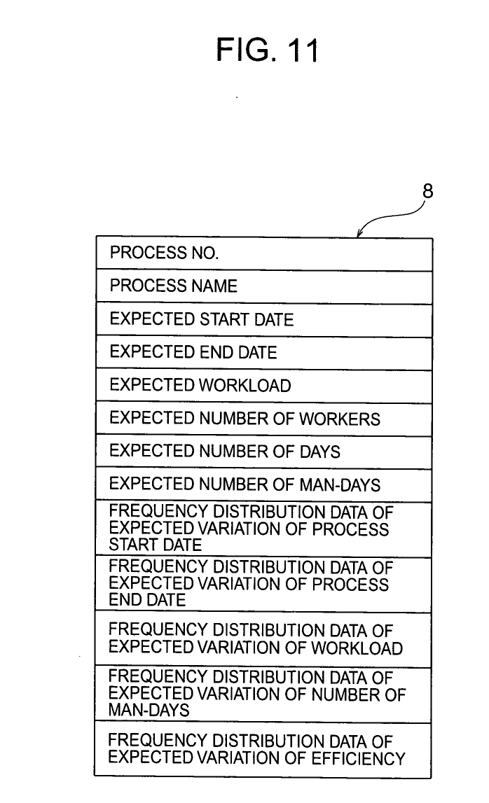

FIG. 11 is a table showing the contents of the evaluation result database 8 corresponding to a process. As shown in FIG. 11, the evaluation result database 8 (for storing information on expected processes which has been obtained by the above procedure) stores the information for each process such as “process No.”, “process name”, “expected start date”, “expected end date”, “expected workload”, “expected number of workers”, “expected number of days”, “expected number of man-days”, “frequency distribution data of expected variation of process start date”, “frequency distribution data of expected variation of process end-date”, “frequency distribution data of expected variation of workload”, “frequency distribution data of expected variation of number of man-days” and “frequency distribution data of expected variation of efficiency”, for example.

<Display Screen>

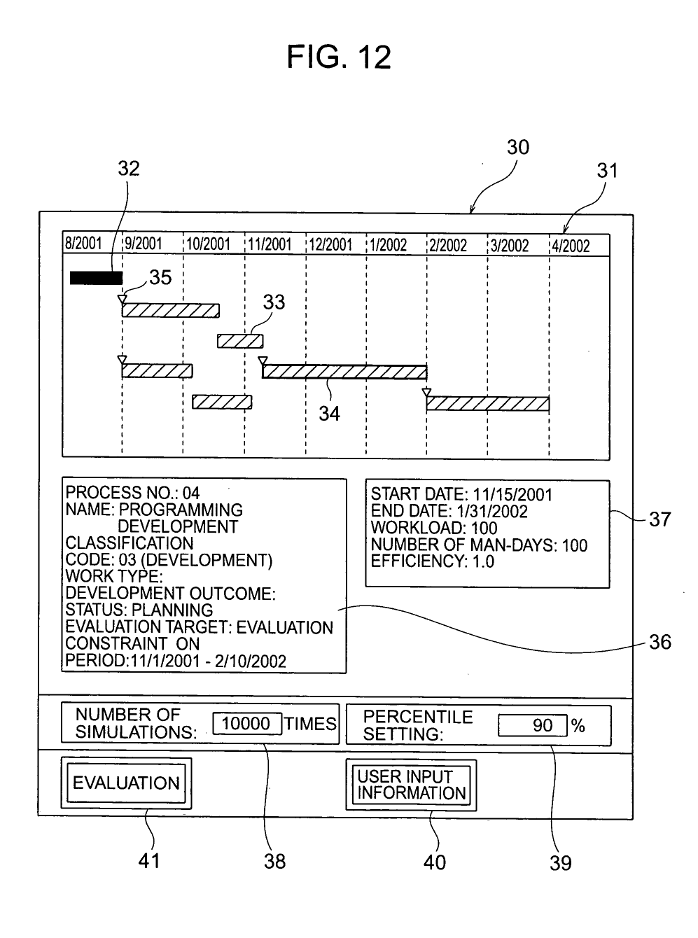

FIG. 12 is a schematic diagram showing an example of a display screen which is first outputted or transmitted by the display unit 9 when a user hoping to know the evaluation of the process plan made access to the evaluation device (implemented by a server computer connected to a network) from a terminal device via the network. In the following example, a case where the project pre-review estimate method of the present invention is applied to a software development project will be described.

The display screen 30 shown in FIG. 12 includes a process display area 31, in which the information on the scheduled processes and the performed processes stored in the process database 3 is displayed in the form of a Gantt chart. In the Gantt chart, diagonally shaded bars 33 represent the scheduled processes while solid bars 32 represent the performed processes. When the user selects a bar (representing a process) in the process display area 31 by a mouse, etc., basic information and quantitative information about the selected process are displayed. The display screen 30 of FIG. 12 is an example a screen which is displayed when a process 34 is selected with the mouse, in which the basic information on the selected process is displayed in an area 36 and the quantitative information on the selected process is displayed in an area 37.

Below the areas 36 and 37, a simulation number entry box 38 having a text box used for entering the number of Monte Carlo simulations in the evaluation procedure described above and a percentile entry box 39 having a text box used for entering a percentile to be used for displaying each of the aforementioned expected variations (calculated as probability distribution) are displayed. The user can carry out the evaluation of the process plan by entering arbitrary values into the entry boxes. It is also possible to previously set proper default values in the entry boxes 38 and 39 as initial values.

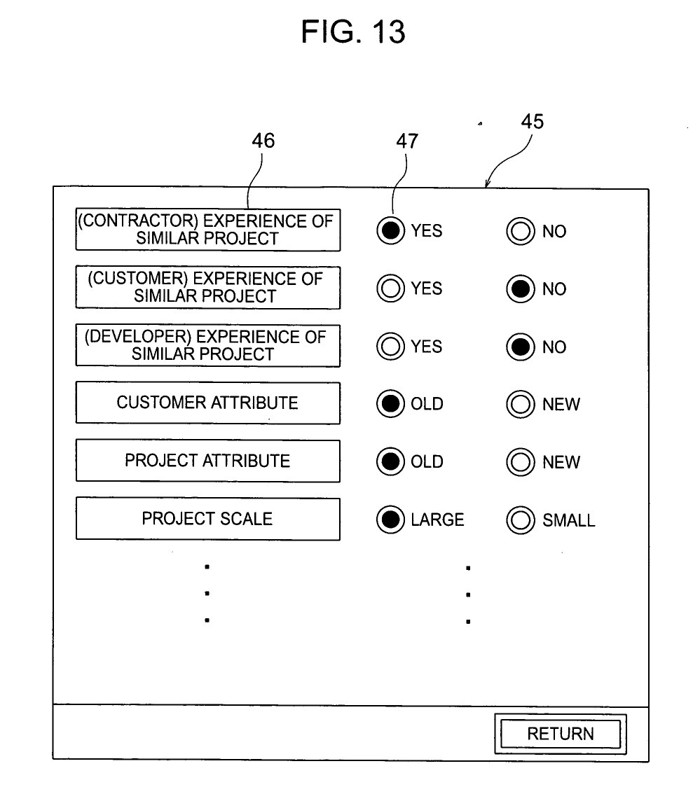

For inputting qualitative information on the process selected on the display screen 30 of FIG. 12, the user presses or clicks a user input information button 40 at the bottom of the screen, by which the display screen is switched to, for example, a display screen 45 of FIG. 13 for inputting the qualitative information on the process. On the display screen 45, the user selects a piece of information regarding the selected process (shown with a reference numeral 46, for example) by pressing or clicking a radio button 47 (which allows exclusive selection) and thereby enters information to each item. Incidentally, the entry of the number of simulations and the percentile into the entry boxes on the display screen 30 of FIG. 12, the selection of the process (to be evaluated) with the mouse, and the entry of the qualitative information about the process on the display screen 45 of FIG. 13 correspond to the step S102 of the flow chart of FIG. 10. The information entered as above is stored in each database explained above.

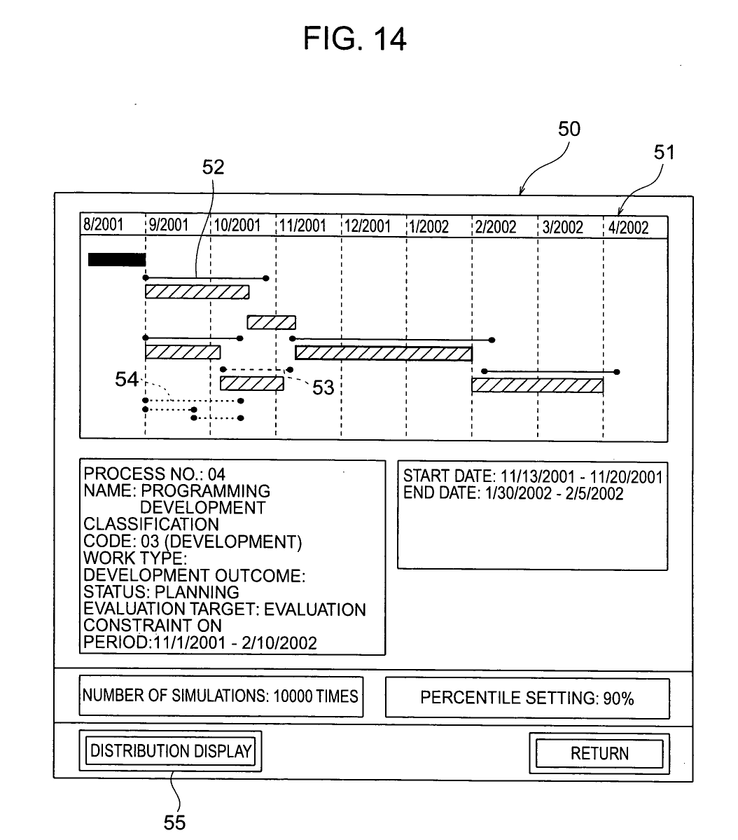

For carrying out the evaluation of the process plan after entering necessary information into the display screens 30 and 45 of FIGS. 12 and 13, the user presses or clicks an evaluation button 41 at the bottom of the display screen 30 of FIG. 12. In response to the selection of the evaluation button 41, the evaluation device executes the sequence from the step S103 of the flow chart of FIG. 10, registers the result of the evaluation with the evaluation result database 8, and outputs, for example, a display screen 50 shown in FIG. 14 to the display unit 9. In the display screen 50, an expected process 52 obtained for the process selected as the evaluation target is displayed in a process chart display area 51. If the evaluation has found a possibility that an existing process might be deleted, a broken line 53 is drawn along the process that can be deleted in order to indicate the possibility. On the other hand, if there is a possibility that a process might be added, the process is displayed on the screen with a display method different from that for existing processes (dotted line 54, for example). Below the dotted line 54, other processes that might be added are also shown.

When the user hopes to see frequency distribution information on specific quantitative information regarding a particular process, the user selects the process with the mouse and then selects a distribution display button 55 at the bottom of the display screen 50, by which the display screen is switched to a screen (frequency distribution display screen 60) for displaying the frequency distribution of specific quantitative information about the selected process.

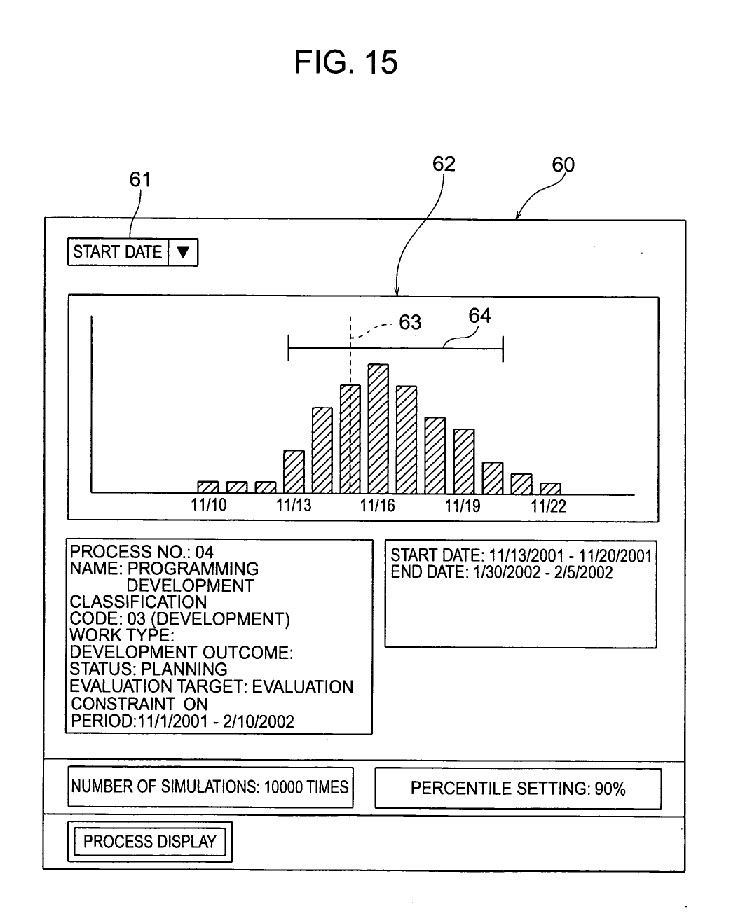

FIG. 15 is a schematic diagram showing an example of the frequency distribution display screen 60 regarding the start date of the selected process. The frequency distribution display screen 60 shown in FIG. 15 includes a pull-down menu 61 at the top of the screen to be used for switching the quantitative information displayed on the screen and a frequency distribution display area 62 for displaying a frequency distribution graph of the selected quantitative information. The items shown in the pull-down menu 61 include the “start date”, “end date”, “workload” and “man-days” of the selected process, for example. In the frequency distribution display area 62, the horizontal axis of the graph represents the date and the vertical axis represents the frequency. The scheduled start date at the stage of planning is indicated with a broken line 63, while a variation range 64 of the start date is indicated based on the percentile entered into the percentile entry box 39 on the display screen 30 of FIG. 12.

By the project pre-review estimate method in accordance with the above embodiment of the present invention, the user is allowed to refer to the evaluation result of each process by easy operation and thereby carry out secure and reliable process management based on the evaluation result of the process plan.

While a specific example of an application of the evaluation device employing the project pre-review estimate method in accordance with the present invention has been described in the above embodiment, the present invention is widely applicable to a variety of project management such as process management in hardware development and process management in plant construction. The present invention is not to be restricted by the above particular illustrative embodiment but only by the appended claims. It is to be appreciated that those skilled in the art can change or modify the embodiments without departing from the scope and spirit of the present invention. For example, the method of the present invention can be incorporated and employed in a conventional project evaluation device. In such cases, the storage unit of the conventional evaluation device can also be used as the storage unit according to the present invention and many other parts can also be shared.

1. A project pre-review estimate method for previously evaluating a project including one or more processes and examining process alteration that can occur to a process plan of the project in the future by use of an evaluation device comprising at least storage means and processing means, wherein:
the storage means prestores factor information on one or more expected process alterations and influence information indicating influence of each process alteration on the process plan associating the factor information and the influence information with each other, and
the processing means executes:
a factor information selection procedure for stochastically selecting one or more pieces of factor information from the factor information stored in the storage means; and
a process evaluation procedure for calculating variations of parameters indicating quantitative variation and structural change in the process plan based on the influence information associated with the selected factor information.

2. A project pre-review estimate method for previously evaluating a project including one or more processes and examining process alteration that can occur to a process plan of the project in the future by use of an evaluation device comprising at least storage means and processing means, wherein:
the storage means stores:
process plan information on the project;
process performance information on the project up to the point in time;
qualitative information on each process;
factor information on one or more process alterations which can be expected to occur; and
scenario information containing one or more scenarios each of which defines probability of occurrence of each process alteration and influence information indicating influence of the process alteration on the process plan, and
the processing means executes:
a scenario selection procedure for extracting one or more scenarios from the scenario information by use of random numbers and determining whether each of the scenarios will occur or not based on probability of occurrence of each scenario; and
a process evaluation procedure for calculating expected variations of one or more pieces of the qualitative information on a process of the project based on the contents of the scenario that has been determined by the scenario selection procedure to occur, the process plan information on the project, the process performance information on the project up to the point in time and the qualitative information on the process.

3. The project pre-review estimate method according to claim 2, wherein:
one or more pieces of information selected from “whether a contractor has experienced a similar project”, “whether a customer has experienced a similar project”, “whether development is carried out by experts or nonexperts”, “old customer or new customer”, “old subcontractor or new subcontractor” and “large-scale project or small-scale project” can be set as the qualitative information, and
the scenario selection procedure corrects the scenario occurrence probability and the influence information indicating the influence on processes contained in the scenario information based on the qualitative information.

4. The project pre-review estimate method according to claim 3, wherein:
the one or more scenarios contained in the scenario information is classified based on the period of evaluation of the project and the content of the project, and
the scenario selection procedure extracts one or more proper scenarios that correspond to the content of the process as the target of the evaluation based on the classification.

5. The project pre-review estimate method according to claim 4, wherein when the proper scenario is extracted, the scenario selection procedure positively corrects the occurrence probabilities of scenarios having a positive correlation with the proper scenario while negatively correcting the occurrence probabilities of scenarios having a negative correlation with the proper scenario.

6. The project pre-review estimate method according to claim 5, wherein distribution of variation of each parameter regarding quantitative alteration or structural alteration of the project is calculated by repeating a sequence included in the scenario selection procedure and the process evaluation procedure for an arbitrarily set number of times and the calculated distributions are registered with the storage means.

7. The project pre-review estimate method according to claim 6, further comprising a display procedure, wherein:
the display procedure displays the quantitative alteration and the structural alteration of the processes together on a Gantt chart which incorporates performed processes into the process plan, and
when a display part indicating the quantitative alteration or structural alteration is selected, the display procedure displays a frequency distribution graph regarding the selected quantitative alteration or structural alteration on the same screen as the Gantt chart or on a separate screen by use of the distribution of the variation of the parameter regarding the selected quantitative alteration or structural alteration which has been registered with the storage means.

8. The project pre-review estimate method according to claim 7, wherein the influence information is information indicating one or more influence contents targeted at one or more processes.

9. The project pre-review estimate method according to claim 8, wherein the processes as the target of the influence information are one or more processes selected from:
the process as the target of the evaluation;
processes associated with the process as the evaluation target by ordinal constraints;
processes started after the process as the evaluation target; and
processes relevant to work or development outcome of the process as the evaluation target.

10. The project pre-review estimate method according to claim 9, wherein the influence information is one or more pieces of information selected from:
information on specification change in which quantitative values of one or more parameters regarding a particular process are altered;
information on specification addition in which a new process is added to existing processes;
information on rework in which part of existing processes is deleted and replaced with a new process; and
information on interruption in which part of existing processes is deleted.

11. The project pre-review estimate method according to claim 10, wherein the information on the specification change altering quantitative values of parameters is information including one or more alterations selected from:
alteration of a start date of the process as the target of alteration;
alteration of an end date of the process as the target of alteration;
increase of workload;
decrease of workload;
increase of the number of workers;
decrease of the number of workers;
increase of the number of working days;
decrease of the number of working days;
increase of the number of man-days;
decrease of the number of man-days;
increase of working efficiency; and
decrease of working efficiency.
